(19) United States
(12) Patent Application Publication
(10) Pub. No.: US 2012/0033120 A1
(43) Pub. Date: Feb. 9, 2012

(54) SOLID-STATE IMAGING DEVICE AND ELECTRONIC CAMERA

(75) Inventors: Kenji NAKAMURA, Osaka (JP); Hiroshi UEDA, Osaka (JP); Kyoichi MIYAZAKI, Osaka (JP)

(73) Assignee: PANASONIC CORPORATION, Osaka (JP)

(21) Appl. No.: 13/274,482

(22) Filed: Oct. 17, 2011

Related U.S. Application Data
(63) Continuation of application No. PCT/JP2010/001180, filed on Feb. 23, 2010.

(30) Foreign Application Priority Data
Apr. 20, 2009 (JP) 2009-102480

(51) Int. Cl. H04N 5/335

(52) U.S. Cl. 348/302; 348/E05.091

(57) ABSTRACT

An object of the present invention is to provide a highly-accurate AF without adding a mechanism of the camera or increasing the power consumption. A solid-state imaging device according to an aspect of the present invention includes: a plurality of photoelectric conversion units configured to convert incident light into electronic signals, the photoelectric conversion units being arranged in a two dimensional array, the photoelectric conversion units including a plurality of first photoelectric conversion units and a plurality of second photoelectric conversion units; a plurality of first microlenses each of which is disposed to cover a corresponding one of said first photoelectric conversion units; and a second microlens disposed to cover the second photoelectric conversion units, in which at least two of the second photoelectric conversion units are located at respective positions which are offset from an optical axis of the second microlens, in mutually different directions.

### CROSS REFERENCE TO RELATED APPLICATION

This is a continuation application of PCT application No. PCT/JP2010/001180 filed on Feb. 23, 2010, designating the United States of America.

### BACKGROUND OF THE INVENTION

(1) Field of the Invention

The present invention relates to solid-state imaging devices and electronic cameras, and particularly relates to a solid-state imaging device and an electronic camera having an auto focus (AF) function.

(2) Description of the Related Art

Recently, applications for handling images by a computer have been significantly increased. Particularly, a digital camera for taking images into a computer has been extensively commercialized. The development of such a digital camera, especially a digital still camera handling still images, shows clear tendency of increased number of pixels.

For example, the number of pixels of an imaging element of a camera for moving pictures (video movie) is generally 250,000 to 400,000, while a camera having an imaging element including 800,000 pixels (XGA class: eXtended Graphic Array) has been widely used. More recently, a camera in the market often has an imaging element including approximately one million to 1.5 million pixels. Moreover, with respect to a high-class camera having an interchangeable lens, a high-pixel-density imaging element having a large number of pixels such as two million pixels, four million pixels, or six million pixels has also been commercialized.

In a video movie camera, the control of the camera capturing system, such as an auto focus (AF) function, is performed using an output signal of the imaging element to be serially output at a video rate. Therefore, TV-AF (hill-climbing method, contrast method) is used for the AF function in the video movie camera.

Meanwhile, various methods are used for the digital still camera according to the number of pixels and an operating method of the camera. Most of the digital still cameras including 250,000 pixels to 400,000 pixels, which are commonly used in the video movie camera, generally display a repeat read signal (image) from a sensor on a color liquid crystal display (Thin Film Transistor (TFT) liquid crystal display of approximately two inches is often used recently) provided to each digital still camera (hereinafter, referred to as a finder mode, or electronic view finder mode (EVE mode: Electric View Finder)). These cameras basically operate in the same manner as the video movie camera, and thus a method similar to that of the video movie camera is often used.

However, as to the digital still camera having an imaging element including 800,000 pixels or more (hereinafter, high-pixel-density digital still camera), used is a driving method such that signal lines or pixels unnecessary for displaying an image on the liquid crystal display are thinned out as much as possible to speed up a finder rate (so as to be closer to the video rate) for the operation of the imaging element in a finder mode.

In addition, a full-scale digital still camera such as a camera having more than one million pixels is strongly desired to be capable of instantly capture a still image in the same way as a silver salt camera. Therefore, such a camera is required to have shorter duration time from the time when a release switch is pressed until the capturing is performed.

Accordingly, various AF methods are used for a high-pixel-density digital still camera. For example, the high-pixel-density digital still camera has a sensor for the AF other than the imaging element, and uses an AF method as it is used for the silver salt camera, such as a phase difference method, contrast method, rangefinder method, and active method.

However, when a sensor other than the imaging element is included for AF, a lens system for forming an image to the sensor and a mechanism for achieving each of the AF methods are necessary. For example, in the active method, a generation unit of infrared light, a lens for projection, a light-receiving sensor, a light-receiving lens, and a transfer mechanism of the infrared light are necessary. Moreover, in the phase difference method, an imaging lens for forming an image to a distance measurement sensor, and a glass lens for providing a phase difference are necessary. Therefore, the size of the camera itself needs to be increased, which naturally leads to increase in cost.

Furthermore, there are more factors which cause errors compared to the AF using the imaging element itself. For example, errors may be caused by difference in paths between the optical system to the imaging element and the optical system to the AF sensor, a manufacturing error in a mold member and so on included in each of the optical systems, and an error caused by expansion due to temperature. Such error components in the digital still camera having an interchangeable lens are larger than that in the fixed lens digital still camera.

Therefore, AF methods using an output of the imaging element itself are to be searched. Of the AF methods, the hill-climbing method has such a disadvantage that longer time is required for being in-focus. Therefore, Japanese Unexamined Patent Application Publication No. 9-43507 (Patent Reference 1) suggests a method of adjusting focus of the lens by providing, to a lens system for forming an image to an imaging element, a mechanism for moving pupil positions to positions symmetrical to an optical axis and calculating a defocus amount from a phase difference of an image obtained through each pupil.

With this method, a high-speed and highly accurate AF has been achieved. This is because that several specific lines in the imaging element are read and the other lines are cleared at high speed for the AF, and thus reading signals does not take much time.

In addition, Japanese Patent No. 3592147 (Patent Reference 2) discloses a different method in which an optical axis of each of the light receiving pixels is formed such that pupil positions are symmetrical to an optical axis for capturing using a light-shielding film provided on a light-receiving pixel of the solid-state imaging device. It has been proposed that with this method, the mechanism for moving the pupil positions, which should be provided to the optical system for capturing, is no longer necessary and the camera can be downsized.

### SUMMARY OF THE INVENTION

However, the above-mentioned conventional high-pixel-density digital still cameras have the following problems.

The method disclosed in Patent Reference 1 requires a mechanism for moving pupils in the digital still camera. Therefore, the volume of the digital still camera is increased, requiring high cost.

Moreover, in the method disclosed in Patent Reference 2, the amount of light entering the light-receiving pixel for the AF is extremely limited by the light-shielding film provided on the light-receiving pixel. Therefore, the method has such a disadvantage that degradation of the AF function in a dark place is easily causing.

Therefore, the present invention is conceived in view of the above problems, and it is an object of the present invention to provide a solid-state imaging device and an electronic camera capable of a highly-accurate AF without adding a mechanism of the camera or increasing power consumption.

In order to solve the above-mentioned problems, a solid-state imaging device according to an aspect of the present invention includes: a plurality of photoelectric conversion units configured to convert incident light into electronic signals, the photoelectric conversion units being arranged in a two dimensional array, the photoelectric conversion units including a plurality of first photoelectric conversion units and a plurality of second photoelectric conversion units; a plurality of first microlenses each of which is disposed to cover a corresponding one of said first photoelectric conversion units; and a second microlens disposed to cover the second photoelectric conversion units, in which at least two of the second photoelectric conversion units are located at respective positions which are offset from an optical axis of the second microlens, in mutually different directions.

With this configuration, the highly-accurate AF function can be achieved by using some of the photoelectric conversion unit among the plurality of photoelectric conversion unit arranged in a two-dimensional array as a photoelectric conversion unit for controlling focus. Moreover, comparing to the case of having a different sensor in addition to the conventional imaging element, additional camera mechanism is not necessary and thus power consumption is not increased and the cost can be reduced.

Moreover, the first microlens and the second microlens may be different from each other in at least one of reflective index, focal length, and shape.

With this configuration, the microlenses for focus control or for normal image signals can be formed according to each usage.

In addition, each of the photoelectric conversion units may include a color filter, and the at least two of the second photoelectric conversion units include color filters of the same color.

Since signals from the photoelectric conversion units having the color filters of the same color are used in this configuration, the signals can be easily compared and the AF function with higher accuracy can be achieved.

In addition, a predetermined number of the second microlenses may be disposed on the second photoelectric conversion units, such that each of the second microlenses covers a predetermined number of the second photoelectric conversion units, the predetermined number being two or more, and the predetermined number of second microlenses may be arranged along a direction in which the second photoelectric conversion units including the color filters of the same color are arranged.

With this configuration, the alignment direction of the photoelectric conversion units corresponds to the alignment direction of the microlenses, and thus the AF function with higher accuracy can be achieved.

In addition, an electronic camera according to an aspect of the present invention includes the above-mentioned solid-state imaging device.

Moreover, the electronic camera may further include a control unit configured to control focus according to a distance to an object, and the control unit may be configured to control the focus using a phase difference between electric signals converted by the second photoelectric conversion units.

With this configuration, the shift amount of the focus of the camera lens can be calculated from a shift due to the phase difference between two signals, and thus a focus control such as focusing on an imaging element can be performed based on the shift amount of the focus.

According to the present invention, the highly-accurate AF can be achieved without adding a mechanism of the camera or increasing the power consumption.

### FURTHER INFORMATION ABOUT TECHNICAL BACKGROUND TO THIS APPLICATION

The disclosure of Japanese Patent Application No. 2009-102480 filed on Apr. 20, 2009 including specification, drawings and claims is incorporated herein by reference in its entirety.

The disclosure of PCT application No. PCT/JP2010/001180 filed on Feb. 23, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A illustrates an example of an arrangement of photoelectric conversion units and microlenses of a normal pixel group;

FIG. 1B illustrates an example of an arrangement of photoelectric conversion units and microlenses of an AF pixel group;

FIG. 2 is a structural diagram of a full-frame CCD area sensor in a solid-state imaging device according to Embodiment 1;

FIG. 3A is a structural diagram of an image area in the solid-state imaging device according to Embodiment 1, which is viewed from the above;

FIG. 3B is a diagram showing a cross sectional structure and a potential profile of the image area;

FIG. 4A is a plan view of the photoelectric conversion unit of the normal pixels according to Embodiment 1;

FIG. 4B is a cross sectional view showing the structure of the photoelectric conversion unit of the normal pixels according to Embodiment 1;

FIG. 5A is a plan view of the photoelectric conversion units of the AF pixels according to Embodiment 1;

FIG. 5B is a cross sectional view showing the structure of the photoelectric conversion units of the AF pixels according to Embodiment 1;

FIG. 6 illustrates an example of the arrangement of the photoelectric conversion units and microlenses in the solid-state imaging device according to Embodiment 1;

FIG. 7 shows an arrangement of photoelectric conversion units and microlenses in a conventional solid-state imaging device;

FIG. 8A illustrates an example of the case where the focus of the camera lens is on the surface of an imaging region;

FIG. 8B illustrates an example of the case where the focus of the camera lens is not on the surface of the imaging region;

FIG. 9 illustrates an example of an arrangement of the distance measurement region in the imaging area in Embodiment 1;

FIG. 10 is a timing chart showing a read operation for pixels in the solid-state imaging device according to Embodiment 1;

FIG. 11 is a timing chart showing a read operation for distance measurement pixels in solid-state imaging device according to Embodiment 1;

FIG. 12 illustrates an example of the case where the focus of the camera lens is on the surface of the imaging region;

FIG. 13 illustrates an example of the case where the focus of the camera lens is not on the surface of the imaging region;

FIG. 14 is a diagram illustrating image signals read from the first line and the second line of the AF pixel group;

FIG. 15 illustrates a different example of the arrangement of the photoelectric conversion units and microlenses in the solid-state imaging device according to Embodiment 1;

FIG. 16 illustrates a different example of the arrangement of the photoelectric conversion units and the microlenses in the solid-state imaging device according to Embodiment 1;

FIG. 17 is a diagram illustrating an example of a different arrangement of the photoelectric conversion unit and the microlenses in the AF pixel group;

FIG. 18 illustrates an example of a different arrangement of the photoelectric conversion units and the microlenses in the solid-state imaging device according to Embodiment 1;

FIG. 19A is a plane view illustrating a different example of the photoelectric conversion units for the normal pixels and the photoelectric conversion unit for the AF pixels;

FIG. 19B is a structural cross-sectional view showing the different example of the photoelectric conversion unit for the normal pixels and the photoelectric conversion unit for AF pixels; and

FIG. 20 a pattern diagram showing a configuration of the electronic camera according to Embodiment 2.

### DESCRIPTION OF THE PREFERRED EMBODIMENTS

Hereinafter, embodiments of the present invention are described with reference to the drawings.

### Embodiment 1

The solid-state imaging device according to Embodiment 1 includes a plurality of photoelectric conversion units configured to convert incident light to an electronic signal and arranged in a two dimensional array. The photoelectric conversion units are divided into a group of normal pixels having microlenses arranged to correspond in a one-to-one relationship and a group of AF pixels having microlenses arranged to correspond in a many-to-one relationship. In other words, a single microlens is disposed to each set of a predetermined number, which is two or more, of photoelectric conversion units of the photoelectric conversion units included in the AF pixel group.

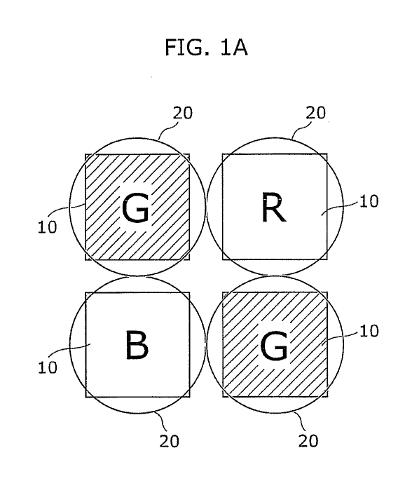

First, a basic pixel arrangement in the solid-state imaging device according to this embodiment is described with reference to FIGS. 1A and 1B. FIG. 1A illustrates an example of an arrangement of photoelectric conversion units 10 and microlenses 20 of the normal pixel group. FIG. 1B illustrates an example of the arrangement of photoelectric conversion units 30 and microlenses 40 of the AF pixel group. Each of the photoelectric conversion units 10 and 30 has a color filter of a primary color.

FIG. 1A illustrates a color arrangement of a basic unit of 2×2 pixels of area sensors. As shown in FIG. 1A, each microlens 20 is disposed to a corresponding one of the photoelectric conversion units 10 to correspond in the one-to-one relationship. In other words, each of the microlenses 20 is disposed to cover a corresponding one of the photoelectric conversion units 10.

Here, FIG. 1A illustrates a primary color filter array in a Bayer pattern, and the photoelectric conversion units 10 having four color filters of R (red), G (green), B (blue), and G (green) are arranged in a checkered pattern. Besides, common arrangements of sensors for a movie camera are a pure color filter array in the Bayer pattern and a complementary color filter array in the Bayer pattern. A description is given for the primary color array in the Bayer pattern in this embodiment, but this can be applied to other methods in the exactly the same manner. This can be also applied to a special form of photoelectric conversion units, in which R, G, and B, or two colors among them are arranged in stripes.

In FIG. 1B, one AF pixel group includes four photoelectric conversion units 30 as an example. Each of the photoelectric conversion units 30 has a color filter arranged in the primary color filter array in the Bayer pattern, while each microlens 40 is disposed to be shared among the photoelectric conversion units. In other words, one of the microlenses 40 is disposed to cover four photoelectric conversion units 30. Here, at least two of the photoelectric conversion units 30 placed under the single microlens 40 include color filters of the same color (which is G in the example of FIG. 1B).

Note that the microlenses 20 of the normal pixel group and the microlenses 40 of the AF pixel group differ in shape (here, size is different) as illustrated in FIG. 1A and FIG. 1B. The microlenses 20 and the microlenses 40 may have different refractive indexes from each other.

Next, the configuration of the solid-state imaging device 100 according to Embodiment 1 including the normal pixel group and the AF pixel group as illustrated in FIG. 1A and FIG. 1B is described.

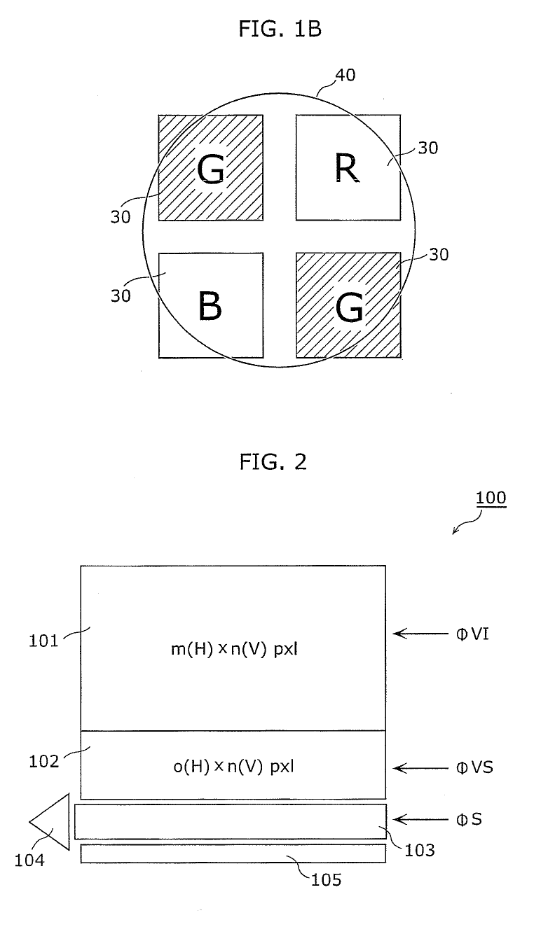

FIG. 2 is a structural diagram of a full-frame CCD (Charged Coupled Device) area sensor according to this embodiment. As illustrated in FIG. 2, the solid-state imaging device 100 includes an image area 101, a storage area 102, a horizontal CCD 103, an output amplifier 104, and a horizontal drain 105.

The image area 101 includes pixels of “m” rows×“n” columns (hereinafter, the vertical line is referred to as a column, and the horizontal line is referred to as a row), and “n” number of photosensitive vertical CCDs (hereinafter, referred to as V-CCDs). In the image area 101, the photoelectric conversion units 10 (normal pixel group) and the photoelectric conversion units 30 (AF pixel group) shown in FIG. 1A and FIG. 1B are arranged in a two-dimensional array.

Here, each of the V-CCDs is usually a two to four phase driving CCD, or a pseudo single-phase driving CCD such as a virtual phase. The pulse for transfer in the CCDs making up the image area 101 is ΦVI. It is obvious that the types of the pulse provided to the V-CCDs depend on the configuration of the V-CCDs. For example, if the V-CCDs are the pseudo one-phase driving CCDs, only one type of pulse is provided, and if they are two-phase driving, two types of pulses are provided to the two-phase electrodes. The same applies to the storage area 102 and the horizontal CCD 103, but only one pulse symbol is indicated for simplicity of the explanation.

The storage area 102 is a memory area in which a given number of “o” rows of the “m” rows in the image area 101 are accumulated. For example, the given number “o” is approximately a few percent of the “m” number. Therefore, the increased chip area in the imaging element due to the storage area 102 is very small. The pulse for transfer in the CCDs making up the storage area 102 is ΦVS. In addition, an aluminum layer is formed on the upper portion of the storage area 102 for shielding light.

The horizontal CCD 103 (hereinafter also referred to as H-CCD) receives, from one line at a time, the signal charge which is photoelectrically converted in the image area 101, and outputs the signal charge to the output amplifier 104. The pulse for transfer in the horizontal CCD 103 is OS.

The output amplifier 104 converts the signal charge of each of the pixels transferred from the horizontal CCD 103 to a voltage signal. The output amplifier 104 is usually a floating diffusion amplifier.

The horizontal drain 105 is formed so that a channel stop (drain barrier) (not shown) is located between the horizontal drain 105 and the horizontal CCD 103, and drains off an unnecessary charge. The signal charges of pixels of an unnecessary region, obtained through partial reading, are drained off to the horizontal drain 105 over the channel stop from the horizontal CCD 103. Note that the unnecessary charge may be efficiently drained by disposing an electrode on the drain barrier between the horizontal CCD 103 and the horizontal drain 105 and changing the voltage provided to the electrode.

Basically, the above-described configuration has a small storage region (storage area 102) provided to a common full-frame CCD (image area 101), and this allows partial reading of signal charges in any region.

Next, each pixel included in the image area 101 is described. In other words, configurations of the photoelectric conversion units 10 and 30 are described. Here, a description is given of the case of virtual phase for convenience.

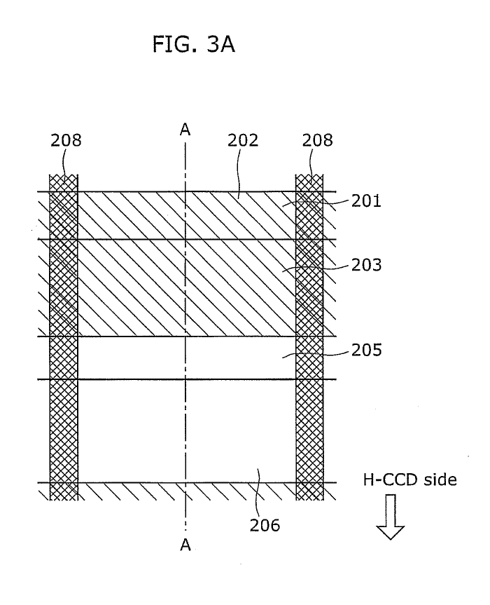

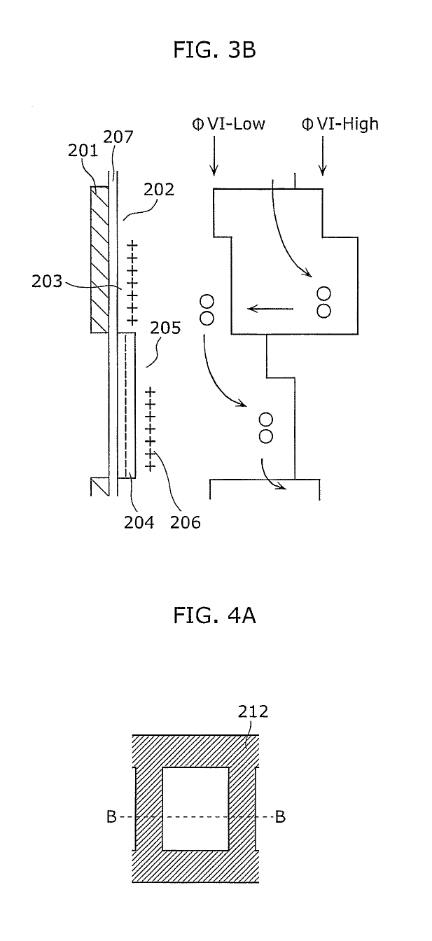

FIG. 3A and FIG. 3B are diagrams illustrating a pixel structure of the image area 101 in the solid-state imaging device 100 according to this embodiment. FIG. 3A is a structural diagram of the image area 101 viewed from the above, and FIG. 3B is a diagram showing a cross-sectional structure taken along the line A-A of FIG. 3A and its potential profile.

In FIGS. 3A and 3B, a clock gate electrode 201 is made of a light-transmitting polysilicon, and the semiconductor surface under the clock gate electrode 201 is a clock phase region. The clock phase region is divided into two regions by ion implantation and one of the regions is a clock barrier region 202, while the other is a clock well region 203 formed by ion implantation such that the potential of the clock well region 203 is higher than that of the clock barrier region 202.

The virtual gate 204 includes a virtual phase region in which a P+ layer is formed on the semiconductor surface so as to fix a channel potential. The virtual phase region is further divided into two regions by implanting N-type ions to a layer deeper than the P+ layer. One of the regions is a virtual barrier region 205 and the other is a virtual well region 206.

An insulating layer 207 is, for example, an oxide film provided between the clock gate electrode 201 and the semiconductor. In addition, channel stops 208 are isolation regions for isolating each of the V-CCD channels.

For V-CCD transfer, a given pulse is applied to the clock gate electrode 201, and the potential value of the clock phase region (the clock barrier region 202 and the clock well region 203) is increased or decreased with respect to the potential value of the virtual phase region (the virtual barrier region 205 and the virtual well region 206), thereby transferring the charges in the transfer direction of the horizontal CCD (FIG. 3B illustrates the concept of the movement of the charges with white circles).

The pixel structure of the image area 101 is as described above, and the pixel structure of the storage area 102 is the same. However, in the storage area 102, the upper portion of the pixel is light-shielded by aluminum, and thus preventing blooming is not necessary. Therefore, an overflow drain is omitted. The horizontal CCD 103 also has a virtual phase structure, and has a layout of a clock phase region and a virtual phase region so that the horizontal CCD 103 can receive charges from the V-CCDs and transfer the charges horizontally.

As described above, the solid-state imaging device 100 according to this embodiment can read the charges accumulated in the image area 101 from the output amplifier 104.

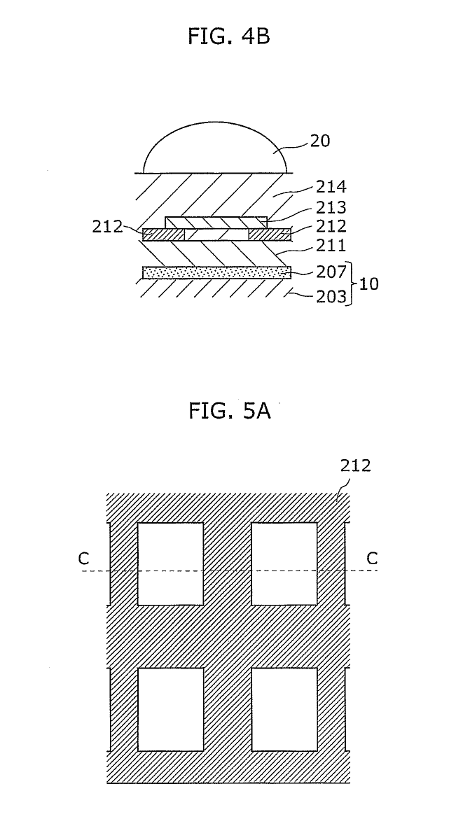

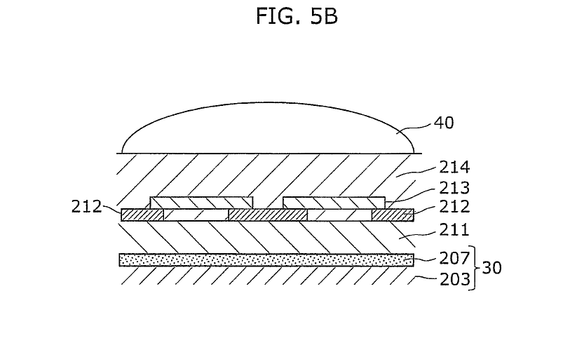

Next, pixel structures of a normal pixel and an AF pixel are described with reference to FIGS. 4A, 4B, 5A, and 5B.

FIG. 4A is a plane view of the normal pixel viewed from the above, and FIG. 4B is a cross sectional view of the normal pixel taken along a line B-B of FIG. 4A. As shown in FIG. 4B, a microlens 20 is formed on the uppermost portion.

The normal pixel includes a planarization film 211 on the insulating layer 207 illustrated in FIGS. 3A and 3B. The normal pixel further includes, on the planarization film 211, a light-shielding film 212 which shields incident light entering a region other than a photoelectric conversion unit 10. In addition, the normal pixel includes a color filter 213 above the light-shielding film 212. On the color filter 213, a planarization film 214 is provided. The planarization film 214 is a smooth layer for structuring a plane surface for forming the microlens 20.

FIG. 5A is a plan view of AF pixels viewed from the above, and FIG. 5B is a cross-sectional view of the AF pixels taken along a line C-C of FIG. 5A. As shown in FIGS. 5A and 5B, the structure of the AF pixels is different from the normal pixel in that the photoelectric conversion units 30 are disposed under the single microlens 40. In other words, a light-shielding film 212 having a plurality of openings is disposed under the single microlens 40, and the photoelectric conversion unit 30 is provided under each of the openings. In other words, the photoelectric conversion units 30 share the single microlens 40.

Next, the following describes in detail about pixels (i.e., photoelectric conversion units) making up the image area 101 in the solid-state imaging device 100 according to this embodiment. Specifically, in the solid-state imaging device 100 according to this embodiment, the photoelectric conversion units 10 (normal pixels) and the photoelectric conversion units 30 (AF pixels) are formed in the image area 101. Each of the photoelectric conversion units 10 has the microlens 20 disposed thereto to correspond in the one-to-one relationship as illustrated in FIG. 1A, and the photoelectric conversion units 30 are included in the single microlens 40 as illustrated in FIG. 1B.

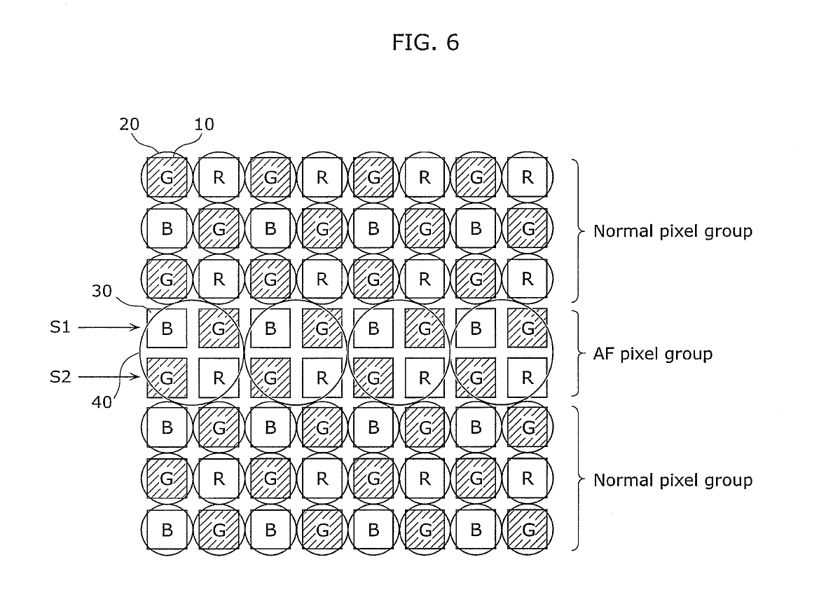

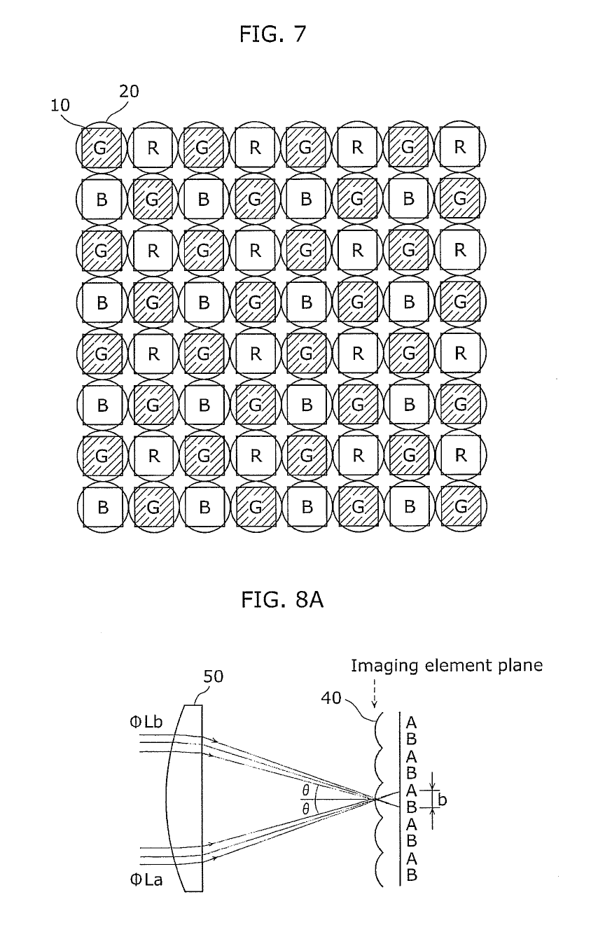

FIG. 6 illustrates a pixel arrangement of the image area 101 in the solid-state imaging device 100 according to this embodiment. For comparison, FIG. 7 shows a pixel arrangement of the image area in a conventional solid-state imaging device.

As shown in FIG. 7, a microlens is conventionally disposed to every pixel (photoelectric conversion unit) to correspond in the one-to-one relationship. In contrast, in this embodiment, the group of AF pixels is formed horizontally in the image area 101 in which the pixels are arranged in the Bayer pattern as shown in FIG. 6.

In the area sensor including over one million pixels, lines S1 and S2 in the arrangement of FIG. 6 are regarded as almost the same line, and proximate images are formed on the microlenses 40. As long as the focus of the camera lens for forming an image on the imaging element (image area) is on the imaging element, image signals from the pixel groups of the lines S1 and S2 match. On the contrary, when the in-focus point (image forming point) is at a position forward or backward in the image area of the imaging element, a phase difference is generated between the image signal from the pixel group of the line S1 and the image signal from the pixel group of the line S2. Note that the direction of the phase shift is opposite depending on whether the imaging point is forward or backward.

In principle, this is the same as the AF using the phase difference of the divided pupils in the above-mentioned Patent Reference 1. The pupil seems as if it is divided into right and left around an optical center when the camera lens is viewed from the photoelectric conversion unit in the line S1 and when the camera lens is viewed from the photoelectric conversion unit in the line S2.

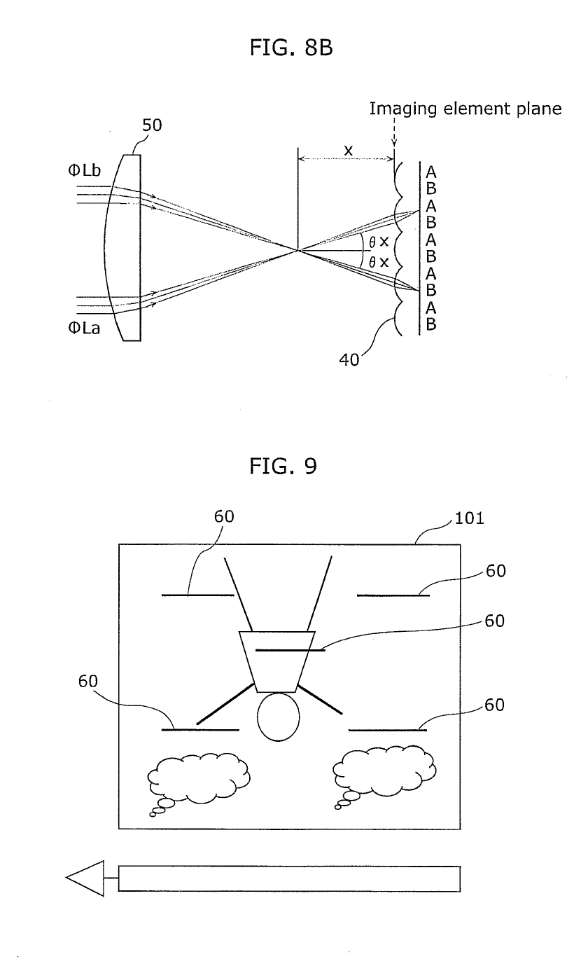

FIG. 8A and FIG. 8B are schematic diagrams showing image shift caused by being out of focus. Here, the lines S1 and S2 are put together and indicated by points A and B. In addition, the color pixels between function pixels are omitted for simplicity, and the pixels are shown as if only the function pixels are aligned.

The light from a specific point of an object is separated into a luminous flux (ΦLa) entering a corresponding point A through an pupil for the point A, and a luminous flux (ΦLb) entering a corresponding point B through a pupil for the point B. The two luminous fluxes are originally generated from one point, and thus when the focus of the camera lens 50 is on the plane of the imaging element, the two luminous fluxes reach a point collected on the same microlens 40 as shown in FIG. 8A.

However, when the focus of the camera lens 50 is on a point which is x short of the plane of the imaging element for example, as shown in FIG. 8B, the light reaching points are shifted from each other by a distance corresponding to 2θx. Suppose it is −x for example, the reaching points are shifted to the opposite direction.

Based on this principle, an image formed by an array of points A (signal line according to intensity of light) and an image formed by an array of points B match with each other if the camera lens 50 is in-focus, and the images do not match if the camera lens 50 is out of focus.

The imaging element according to this embodiment includes a plurality of microlenses disposed thereto so that a plurality of pixels are included in the single microlens 40 based on the principle (see FIGS. 1B and 6). With this configuration, for example, the pixels positioned in the line S1 and those in the line S2 in FIG. 6 are shifted to opposite directions from each other with respect to the optical axis of the microlens 40. Therefore, as described with reference to FIGS. 8A and 8B, the shift amount of the focus of the camera lens 50 is calculated by calculating the shift amount between a line image signal from the line S1 and a line image signal from the line S2 in this region, and the focus of the camera lens 50 is moved by the calculated shift amount of the focus, thereby achieving the auto focus.

Note that such a region having the AF pixels (also called as distance measurement pixels) including the lines S1 and S2 does not need to cover all of the image area 101. In addition, such a region does not need to be one entire line of the image area 101. For example, as shown in FIG. 9, the AF pixels may be embedded into several points in the image area 101 as distance measurement regions 60.

In order to read a signal for measuring a distance (i.e. adjusting the focus of the camera lens 50) from the imaging elements (image area 101), only a line including a distance measurement signal is read, and other unnecessary charges may be cleared at high speed.

The following describes a specific operation of reading the accumulated charges in the image area 101 along a timing chart.

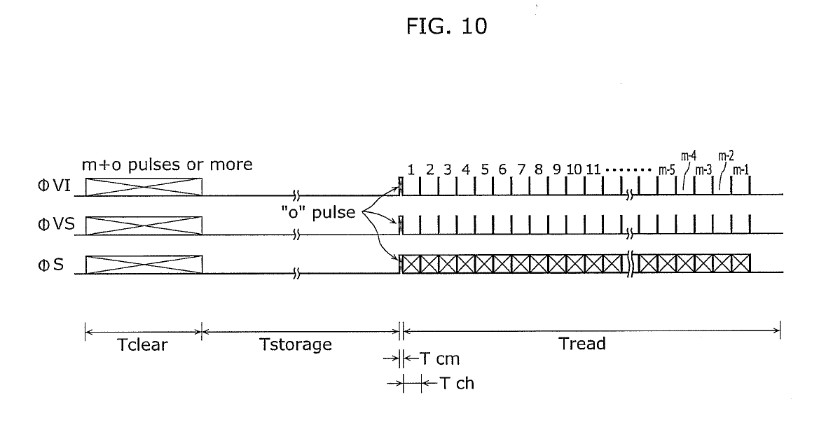

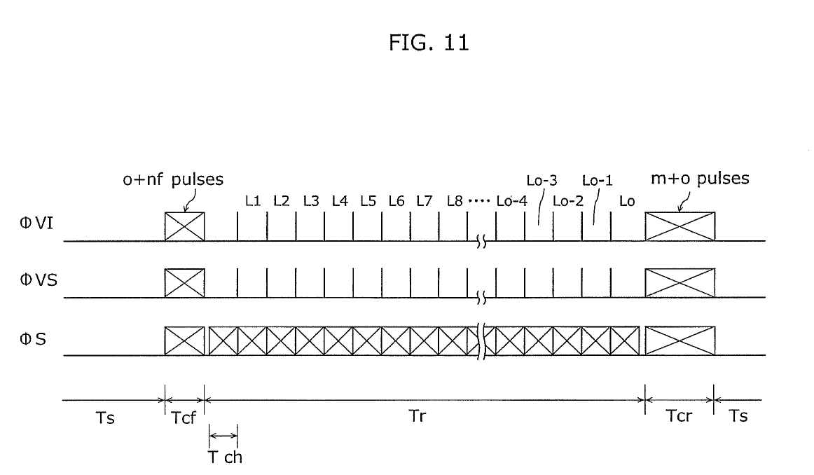

FIG. 10 is a timing chart showing a reading operation for the pixels in the solid-state imaging device 100 according to this embodiment. FIG. 11 is a timing chart showing a reading operation for distance measurement regions 60 in the solid-state imaging device 100 according to this embodiment.

In a usual capturing process, a mechanical shutter disposed on the front plane of the imaging element is initially closed. First, high-speed pulses are applied as ΦVI, ΦVS, and ΦS to perform a clearing operation for draining off the charges in the image area 101 and the storage area 102 (Tclear).

The pulse number of ΦVI, ΦVS, and ΦS at this time is equal to or more than the number of (m+o) of transfer stage in V-CCDs, and the charges in the image area 101 and the storage area 102 are drained off to the horizontal drain 105 and further to a clear drain which is in a subsequent step of the floating diffusion amplifier by the horizontal CCD 103. As long as the imaging element has a gate between the horizontal CCD 103 and the horizontal drain 105, and the gate is opened only during the clearing operation period, the unnecessary charges can be drained more efficiently.

Upon completion of the clearing operation, the mechanical shutter is opened immediately, and the mechanical shutter is closed at the time of obtaining an adequate exposure amount. This time period is called as exposure time (or accumulation time) (Tstorage). The V-CCDs (image area 101 and storage area 102) are stopped during the accumulation time ΦVI and ΦVS are at a low level).

When the mechanical shutter is closed, vertical transfer from the given number of lines “o” is performed (Tcm) first. This operation enables the initial line (a line adjacent to the storage area 102) of the image area 101 to be transferred to a head (a line adjacent to the horizontal CCD 103) of the storage area 102. The transfer for the first given number of “o” lines is performed successively.

Next, before transferring the initial line in the image area 101, the charges of all of the stages of the horizontal CCD 103 is once transferred to clear charges of the horizontal CCD 103 (Tch). With this, the unnecessary charges left in the horizontal CCD 103 at the time of clearing the image area 101 and the storage area 102 (Tstorage) as mentioned above are drained as well as the charges of the dark current of the storage area 102 collected in the horizontal CCD 103 by clearing the storage area 102 (Tcm).

Accordingly, immediately after clearing the storage area 102 (this operation is also called as a reading set operation in which the signal of the initial line of the image area 101 is transferred to the last stage of the V-CCDs contacting the horizontal CCD 103) and clearing the horizontal CCD 103 are completed, the signal charges of the image area 101 are transferred in series starting from the first line to the horizontal CCD 103, and the signal of each line is read sequentially from the output amplifier 104 (Tread). The thus read charges are converted into digital signals by a pre-stage processing circuit including a CDS (Correlated Double Sampling) circuit, an amplifier circuit, and an A/D conversion circuit and the digital signals are processed as image signals.

Usually, since the mechanical shutter needs to be closed at the time of transfer in a full-frame sensor, an AF sensor and an AE sensor are disposed in addition to the full-frame sensor. In contrast, the sensor according to the present invention can read a portion of the image area 101 once, or read repeatedly while the mechanical shutter is opened.

Next, a method of partial reading of the charges accumulated in the distance measurement regions 60 is described with reference to FIG. 11.

First, in order to accumulate signal charges in the storage area 102 from a given number of “o” lines (hereinafter referred to as “no” lines) in a given region in the image area 101 and to perform a transfer for clearing a signal charge in the image region (“nf” line) of previous stage of the accumulated given “no” lines, a clear transfer of the previous stage is performed (Tcf) for draining off the charges of “o”+“nf” lines.

With this, the signal charges accumulated in the “no” lines during the accumulation period (Ts) before the period of transfer Tcf for clearing the previous stage are accumulated in the storage area 102. Immediately after that, the clearing of the horizontal CCD 103 is performed to drain off the remaining charges in the horizontal CCD 103, which have not been cleared at the time of clearing the previous stage (Tch).

After that, the signal charges of the “no” number of lines in the storage area 102 are transferred to the horizontal CCD 103 on a line-to-line basis and are read from the output amplifier 104 sequentially (Tr). When the reading of signals of the “no” number of lines is finished, the clearing operation is performed for all of the stages in the imaging element (Tcr). With this operation, partial reading at high speed is finished. Repeating of this process in the same manner allows successive driving of the partial reading.

In the method of performing the AF by measuring the phase difference between the formed images, signal charges accumulated in several positions in the image area 101 may be read to perform reading for the AF. For example, suppose that the distance measurement regions are positioned at three positions in the image area 101, at a side of the horizontal CCD 103, and at an intermediate position, and at the opposite side of the horizontal CCD 103. At this time, in the sequence (Tcr-Ts-Tcf-Tr) of the first time, signals are read from the distance measurement region at the side of the horizontal CCD 103. In the sequence of the second time, signals are read from the distance measurement region at the intermediate position. In the sequence of the third time, signals are read from the distance measurement region at the opposite side of the horizontal CCD 103. As such, the reading is repeated by changing the positions to be read to measure differences of the several in-focus positions and to perform weighting.

Note that the method of changing the one-cycle operation of the partial reading and changing the positions to be read is described, but signals may be read (accumulated in the storage area 102) from a plurality of positions in one cycle. For example, immediately after o/2 lines are input to the storage area 102, the voltage of the electrode of the storage area 102 is set High (that is, a wall is formed to stop transfer of the signal charge from the image area 101). In order to transfer the necessary charges of up to “o” lines to the virtual well in the last stage of the V-CCD, pulses of several stages up to a stage of the next necessary signal is applied to the electrode of the image area 101.

With this, the charges of up to the transferring of the next necessary signal is transferred to the virtual well of the last stage, and the charges exceeding the over flow drain barrier are drained to the over flow drain. Next, transfer pulses of o/2 pulses are applied to the electrode of the image area 101 and the electrode of the storage area 102, and the signals of first o/2 lines are accumulated in the storage area 102, and then after the line of the signal left from the clearance of the intermediate position is invalidated, the signals of (o/2)-1 signal lines in the second region are accumulated in the storage area 102.

Furthermore, when the signals in the three regions are to be stored in the storage area 102, signals in the third region may be stored by performing the clearing operation of the intermediate position of the second time after the signals of the intermediate position of the second time are stored. Needless to say, if the number of the regions to be stored is increased, the number of lines to be stored for each region is reduced. As such, if data is read from a plurality of portions in one cycle, a faster AF may be achieved than that performed by reading a different region in each cycle as described above.

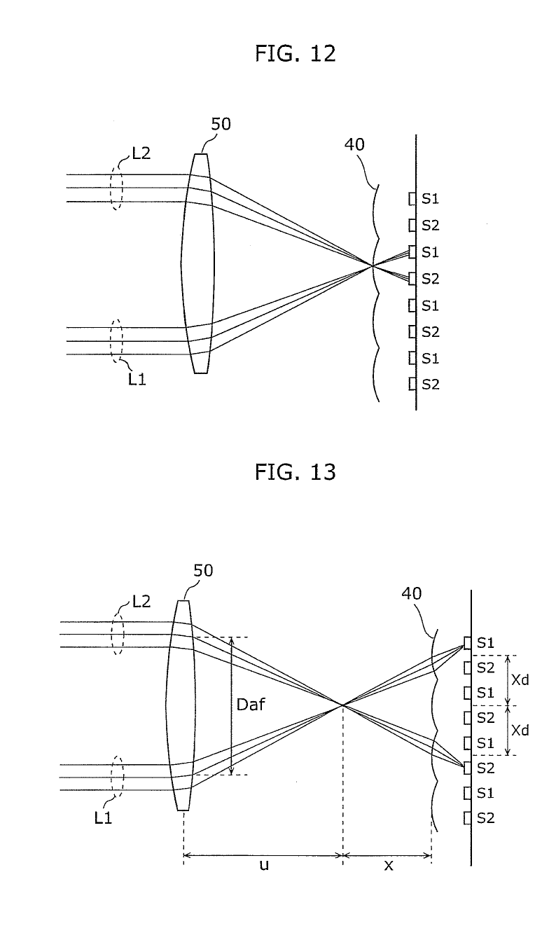

The following describes a method of calculating a defocus amount for achieving the AF function in the solid-state imaging device 100 according to this embodiment, that is, a method of detecting focus is described with reference to FIGS. 12 to 14. In FIGS. 12 and 13, S1 and S2 are shown on the same plane for illustrative purposes. Note that the defocus amount represents a shift amount of the focus, and is indicated by the distance from the surface of the imaging element to a point at which the incident light is collected.

The light from a specific point of an object is separated into a luminous flux (L1) entering S1 through a pupil for S1 and a luminous flux (L2) entering S2 through a pupil for S2. These two luminous fluxes are collected to one point on the surface of the microlenses 40 as shown in FIG. 12. Then, the same image is exposed on S1 and S2. With this, the image signals read from the line S1, and the image signal read from the line S2 become the same signal.

On the other hand, if the camera is out of focus, as shown in FIG. 13, L1 and L2 cross at a different point which is not on the surface of the microlenses 40. Here, the distance between the surface of the microlenses 40 and the intersection point of the two luminous fluxes, that is, the defocus amount, is “x”. In addition, the amount of difference generated at this time between the image of S1 and the image of S2 is “p” pixels, and a sensor pitch (a distance between the adjacent photoelectric converting units) is “d”, and the distance between the centroids of the two pupils is “Daf”, and the distance from the principle point of the camera lens 50 to the focus point is “u”.

Here, the defocus amount x is expressed by Expression (1).

x=p×d×u/Daf (1)

Furthermore, “u” is considered to be almost equal to the focal distance “f” of the camera lens 50, and thus the defocus amount “x” is expressed by Expression (2).

x=p×d×f/Daf (2)

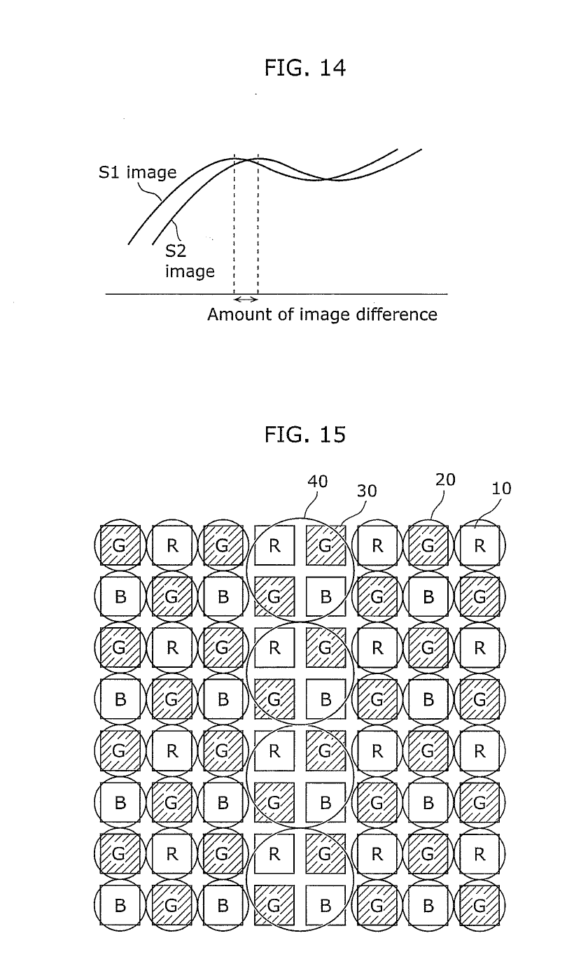

FIG. 14 is a diagram illustrating the image signals read from the line S1 on the imaging element, and the image signals read from the line S2 on the imaging element. A difference, p×d, of image is generated due to the difference between the image signals read from the line S1 and the image signals read from the line S2. The amount of difference between the two image signals is determined to obtain the defocus amount “x”, and the camera lens 50 is shifted by the distance “x”. With this process, the auto focus can be achieved.

Meanwhile, in order to generate the image shift as describe above, the luminous fluxes L1 and L2, which have passed two different pupils among the light entering the camera lens 50, need to be separated. In the method according to the present invention, the pupil division is performed by forming, on the imaging element, a cell having a pupil dividing function for detecting focus.

As described above, in the solid-state imaging device 100 according to this embodiment, the photoelectric conversion units 10 and 30 arranged in a two-dimensional array in the image area 101 are divided into a group of the normal pixels and a group of the AF pixels, and the single photoelectric conversion unit 40 is disposed on a predetermined number of photoelectric conversion units 30 which belong to the AF pixel group. At this time, at least two of the predetermined number of photoelectric conversion units 30 are located at respective positions which are offset from an optical axis of the microlens 40, in mutually different directions.

With this configuration, as described with reference to FIGS. 12 to 14, the defocus amount “x” of the camera lens 50 can be calculated from the shift amount between the two image signals, and focus of the camera lens 50 can be controlled based on the calculated defocus amount “x”. Therefore, the AF function can be achieved with higher accuracy.

Note that the arrangement of the distance measurement pixels and the microlenses is not limited to the arrangement of the horizontal direction as shown in FIG. 6. The microlenses may be arranged in the vertical direction as shown in FIG. 15. In addition, the distance measurement pixels and the microlenses may be arranged as described in the following.

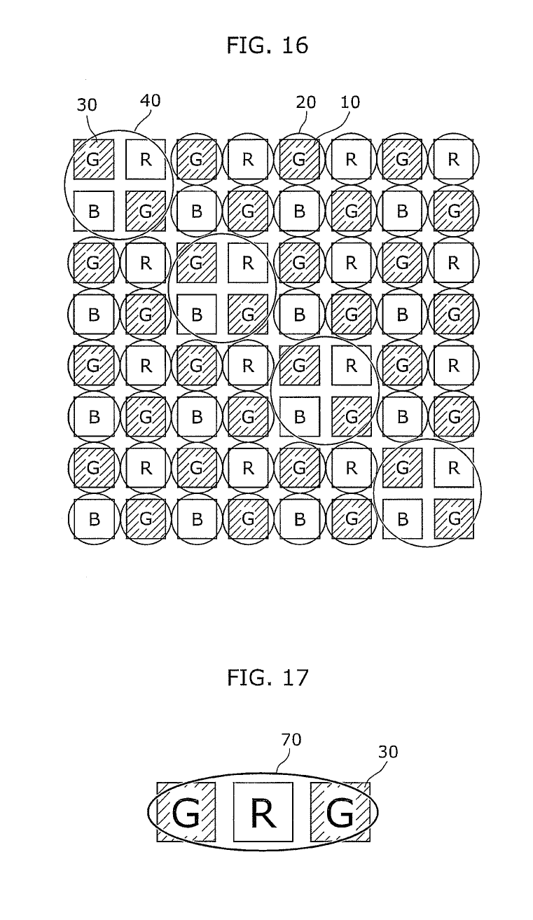

FIGS. 16 to 18 are diagrams each showing a different example of the arrangement of the distance measurement pixels in the image area 101. In the embodiment described so far, the first phase detection line (S1) and the second phase detection line (S2) are slightly shifted from each other. Specifically, as shown in FIG. 6, the alignment direction of the distance measurement pixels (photoelectric converting units each having a G color filter) included in one microlens does not correspond to the alignment direction of the distance measurement microlenses. This will not be practically a problem in the imaging element including over one million pixels, but it is more preferable that the alignment direction of the distance measurement pixels correspond to the alignment direction of the distance measurement microlenses.

In an example shown in FIG. 16, the alignment direction of the distance measurement pixels corresponds to the alignment direction of the distance measurement microlenses in the direction of diagonally downward right.

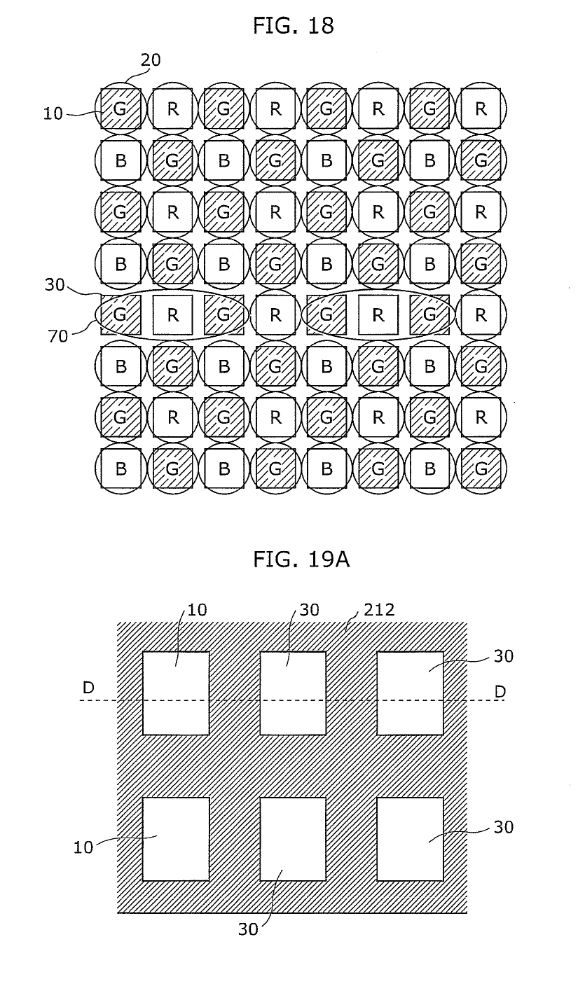

In addition, in the example shown in FIG. 17, the shape of the microlens is changed to be an ellipse when it is viewed from the above. By disposing the ellipse microlenses 70 as shown in FIG. 18, the alignment direction of the microlenses 70 corresponds to the alignment direction of the distance measurement pixels (photoelectric conversion units 30 each having the G color filter).

With this configuration, higher AF accuracy can be obtained, and the number of the photoelectric conversion units which belong to the AF pixel group can be minimized, in other words, the maximum number of normal pixels can be disposed.

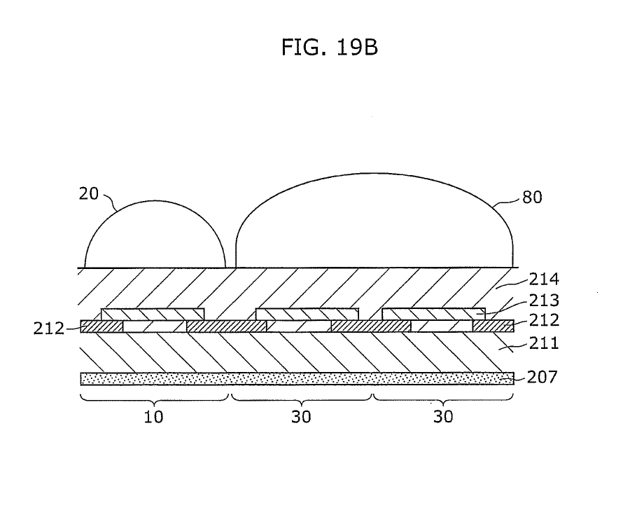

Furthermore, the distance from the top of the microlens to the top of the photoelectric conversion unit (that is, focal distance) may differ between the normal pixels and the AF pixels. A specific configuration is shown in FIG. 19A and FIG. 19B.

FIG. 19A is a plane view showing a different example of the photoelectric conversion units 10 for the normal pixels and photoelectric conversion units 30 for the AF pixels. FIG. 19B is a structural cross-sectional view of the different example of the photoelectric conversion units 10 for the normal pixels and photoelectric conversion units 30 for the AF pixels.

As shown in FIG. 19B, the microlens 20 for the normal pixels and a microlens 80 for the AF pixels are formed on the planarization film 214. Moreover, the microlens 20 and the microlens 80 each have a different thickness. In other words, the distance from the top of the microlens 20 to the surface of the photoelectric conversion unit 10 differs from the distance from the top of the microlens 80 to the surface of the photoelectric conversion unit 30. Therefore, the focal distance of the microlens 20 for the normal pixels differs from the focal distance of the microlens 80 for the AF pixels.

Accordingly, an object image can be appropriately formed by the photoelectric conversion unit 30 for the AF pixels by having microlenses which differ in shape between the normal pixels and the AF pixels.

Note that FIG. 19B illustrates an example in which thickness of the microlens 80 is larger than that of the microlens 20, and this may be vice versa, that is, the thickness of the microlens 20 may be larger than the microlens 80.

### Embodiment 2

The electronic camera according to this embodiment is an electronic camera having an AF function and including the solid-state imaging device described in Embodiment 1.

Note that the electronic camera according to this embodiment may be a movie camera having a function of capturing moving pictures, an electronic still camera having a function of capturing still image, and other cameras such as an endoscope and a monitoring camera. These cameras are essentially the same.

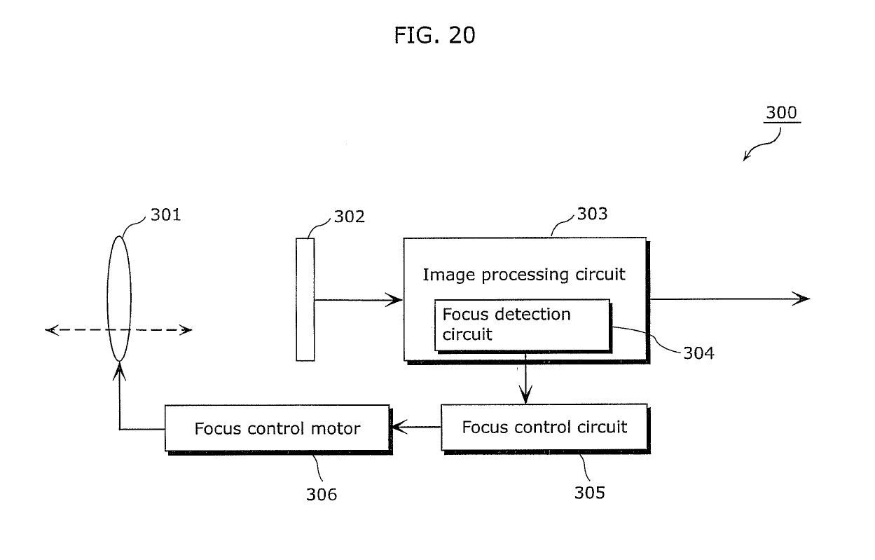

FIG. 20 is a schematic view showing a configuration of an electronic camera 300 according to this embodiment. The electronic camera 300 shown in FIG. 20 includes an image capturing lens 301, a solid-state imaging element 302, an image processing circuit 303, a focus detection circuit 304, a focus control circuit 305, and a focus control motor 306.

The incident light entering through the imaging lens 301 (focus lens) forms an image on the solid-state imaging element 302. The solid-state imaging element 302 corresponds to the solid-state imaging device 100 according to Embodiment 1, and includes a plurality of photoelectric conversion units divided into the normal pixel group and the AF pixel group and arranged in a two-dimensional array.

The electronic signal output from the solid-state imaging element 302 is processed by the image processing circuit 303 (image processor) and an object image is generated. At this time, electronic signals which belong to the AF pixel group are input to the focus detection circuit 304, and are converted into the distance data (defocus amount “x”).

The focus control circuit 305 generates a control signal for controlling the focus control motor 306 based on the distance data to control the focus control motor 306. The focus control motor 306 drives the imaging lens 301 (focus lens) and adjusts the focus of the imaging lens 301 onto the solid-state imaging element 302.

Note that the image processing circuit 303 is configured to output at least one of the image data, distance data, and focus detection data, and the electronic camera 300 may be configured to output and record the data.

As described above, a small number of the function pixels (AF pixels) for measuring distance and light other than the pixels (normal pixels) for taking in image information are provided in the pixels making up the solid-state imaging element 302. With this, the electronic camera 300 according to this embodiment is capable of obtaining distance information or the like for the AF on a plane which is usually used for capturing by using the imaging element itself.

With this configuration, it is possible to provide a camera which is much smaller and low-cost compared to an electronic camera having another sensor in addition to the imaging element. Furthermore, the operation time for AF may be kept short, and photo-opportunity for a photographer may be increased.

In addition, an extremely accurate AF may be achieved, and thus such a case that a necessary image is lost due to a failure of image capturing may be greatly reduced. In addition, an imaging element which does not include the distance measurement pixels in the pixels to be read for a moving picture or read at the time of using a view finder, and which is capable of reading a sufficient number of pixels necessary for generating a moving picture may be achieved.

Furthermore, the solid-state imaging device according to the present invention does not need to perform compensation for the portions of the distance measurement pixels and the number of pixels is thinned out to a necessary amount for generating a moving picture. Therefore, the generating process of the moving picture can be preformed at high speed. This enables a high image quality view finder including a large number of frames, capturing a moving picture file, and a high-speed light measuring operation, and a prominent imaging device can be achieved at low cost. In addition, since the process which operates in the imaging device can be simplified, the power consumption of the device is reduced.

Although the solid-state imaging device and the electronic camera according to the present invention have been described based on some exemplary embodiments above, the present invention is not limited to those. Many modifications which may be conceived by those skilled in the art in the exemplary embodiments and any combinations of elements in different embodiments without materially departing from the novel teachings and advantages of this invention are included in the scope of the present invention.

For example, the color filters for each photoelectric conversion unit are described to be arranged in the Bayer pattern (the checkered pattern), but they may be arranged in strips. In any case, the color filters disposed in two photoelectric conversion units which calculate the phase difference have the same color.

Furthermore, at least some of the photoelectric conversion units are included in the AF pixel group, and the group of AF pixels is linearly arranged in any one of the directions of vertical, horizontal, and diagonal in the image area 101 in this embodiment. At this time, the AF pixel groups do not need to be adjacent with each other, the AF pixel group and normal pixel group may be disposed in a specific cycle (see FIG. 18).

In addition, the image area 101 is made up of full-frame CCDs, but may be made up of interline CCDs or frame transfer CCDs.

### INDUSTRIAL APPLICABILITY

The solid-state imaging device according to the present invention has an effect of achieving a highly accurate AF function, and may be used for a digital still camera and a movie camera, and so on.

What is claimed is:

1. A solid-state imaging device, comprising:
a plurality of photoelectric conversion units configured to convert incident light into electronic signals, said photoelectric conversion units being arranged in a two dimensional array, said photoelectric conversion units including a plurality of first photoelectric conversion units and a plurality of second photoelectric conversion units;
a plurality of first microlenses each of which is disposed to cover a corresponding one of said first photoelectric conversion units; and
a second microlens disposed to cover said second photoelectric conversion units,
wherein at least two of said second photoelectric conversion units are located at respective positions which are offset from an optical axis of said second microlens, in mutually different directions.

2. The solid-state imaging device according to claim 1,
wherein said first microlens and said second microlens are different from each other in at least one of reflective index, focal length, and shape.

3. The solid-state imaging device according to claim 1,
wherein each of said photoelectric conversion units includes a color filter, and
the at least two of said second photoelectric conversion units include color filters of a same color.

4. The solid-state imaging device according to claim 3,
wherein a predetermined number of said second microlenses are disposed on said second photoelectric conversion units, such that each of said second microlenses covers a predetermined number of said second photoelectric conversion units, the predetermined number being two or more, and
said predetermined number of second microlenses are arranged along a direction in which said second photoelectric conversion units including said color filters of the same color are arranged.

5. An electronic camera comprising
said solid-state imaging device according to claim 1.

6. The electronic camera according to claim 5, further comprising
a control unit configured to control focus according to a distance to an object,
wherein said control unit is configured to control the focus using a phase difference between electric signals converted by said second photoelectric conversion units.
